(19) United States
(12) Patent Application Publication
(10) Pub. No.: US 2012/0139514 A1
(43) Pub. Date: Jun. 7, 2012

(54) SWITCH-MODE POWER SUPPLY WITH ENHANCED CURRENT SOURCE CAPABILITY

(75) Inventor: Esa Kai Paatero, Helsinki (FI)

(73) Assignee: EATON CORPORATION, CLEVELAND, OH (US)

(21) Appl. No.: 12/961,527

(22) Filed: Dec. 7, 2010

(51) Int. Cl. G05F 1/10

(52) U.S. Cl. 323/282

(57) ABSTRACT

A switch-mode power supply includes an input port, an output port, and a power train operably connected to the input port and the output port. The power train includes at least one inductor and at least one switching device. The switch-mode power supply further includes a control logic configured to periodically calculate a current equivalent to current through the at least one inductor and further configured to control operation of the power train at least in part by switching the at least one switching device based on the calculated current.

### FIELD OF THE INVENTION

The present disclosure relates generally to a switch-mode power supply. In particular, the present disclosure relates to a switch-mode power supply with enhanced current source capability.

### BACKGROUND

Conventional switch-mode power supply control circuits measure actual inductor current or an equivalent current in the circuit. The measured current is scaled to be within a measurement range corresponding to a predetermined measurement resolution and scaling for the control circuitry. The control circuitry typically cannot detect current measurements outside of the measurement range. For example, current measurements outside of the measurement range may get clipped.

FIG. 1 illustrates exemplary switch control voltage V_{gs} (e.g., gate-source voltage, base-emitter voltage, and so on) and inductor current I_{L} waveforms for a typical switch-mode power supply.

The current limit threshold for a conventional switch-mode power supply such as one producing the exemplary waveforms of FIG. 1 is set within the measurement range so that the control circuitry can measure the actual inductor or equivalent current and react to the current increasing beyond the current limit threshold.

In reference to the waveforms of FIG. 1, at time zero the switch turns on and the inductor current ramps up. The switch remains on for the duration of the duty cycle until at d₁τ when the switch turns off and the inductor current ramps down. The second cycle is similar to the first. At time τ the switch turns on and the inductor current ramps up. The switch remains on for the duration of the duty cycle until at d₂τ when the switch turns off and the inductor current ramps down.

At the beginning of the third cycle, at time 2τ, the switch turns on and the inductor currents ramps up steeply. The steep rise in the inductor current may be due to a fault (e.g., short circuit, overload, and so on) connected to the output of the switch-mode power supply. At d₃τ the inductor current reaches the current limit threshold and the switch turns off. With the switch off, the inductor current ramps down. The switch turns back on at time 3τ when once again the inductor current rises rapidly until it hits the current limit threshold at d₄τ when the switch turns off and the inductor current ramps down.

As can be seen from FIG. 1, once the inductor current reaches the current limit threshold, the switch is turned off at d₃τ and d₄τ limiting the amount of current available to clear the fault (e.g., blow a fuse, trip a circuit breaker, and so on).

It may be desirable for the power supply to increase the current limit threshold to source additional current to the output during fault conditions to clear the fault. However, sourcing additional current to the output would conventionally require increasing the measurement range so that the higher current limit threshold remains within the measurement range. Increasing the scale of the measurement range would cause a loss of resolution in the measurement.

### SUMMARY

In one embodiment, a switch-mode power supply includes an input port, an output port, and a power train operably connected to the input port and the output port. The power train includes at least one inductor and at least one switching device. The switch-mode power supply further includes a control logic configured to periodically calculate current equivalent to current through the at least one inductor and further configured to control operation of the power train at least in part by switching the at least one switching device based on the calculated current.

In another embodiment, a switch-mode power supply includes an input port, an output port, and a power circuit operably connected to the input port and the output port. The power circuit includes at least one inductor and at least one switching device. The switch-mode power supply further includes a data store configured to store data, and a processor configured to calculate a current corresponding to current through the at least one inductor based at least in part on the stored data. The processor is further configured to generate a signal that causes switching of the at least one switching device based at least in part on the calculated current.

A method of controlling a switch-mode power supply includes in one embodiment calculating inductor current through at least one inductor in the switch-mode power supply, and switching at least one switching device off based on the calculated inductor current reaching a current limit threshold.

### BRIEF DESCRIPTION OF THE DRAWINGS

The accompanying drawings, which are incorporated in and constitute a part of the specification, illustrate various exemplary systems, methods, and so on, that illustrate various exemplary embodiments of aspects of the invention. A person of ordinary skill in the art will appreciate that the illustrated boundaries of components in the figures represent one example of the boundaries. A person of ordinary skill in the art will also appreciate that one component may be designed as multiple components or that multiple components may be designed as a single component. Additionally, an internal component may be implemented as an external component and vice versa. Further, the figures may be drawn not to scale and the proportions of certain parts may be exaggerated for convenience of illustration.

FIG. 1 illustrates exemplary switch control voltage and inductor current waveforms for a conventional switch-mode power supply.

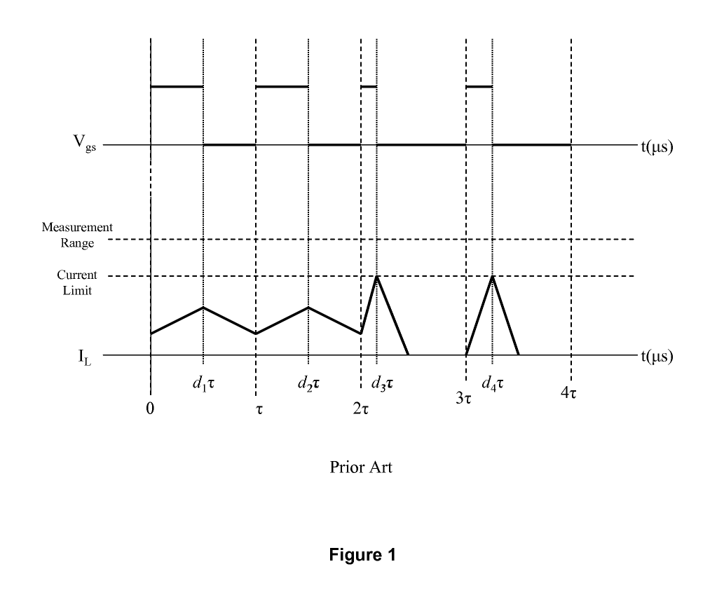

FIG. 2 illustrates a block diagram of an exemplary switch-mode power supply with enhanced current source capability.

FIG. 3 illustrates a circuit diagram of the exemplary switch-mode power supply with enhanced current source capability.

FIG. 4 illustrates an exemplary method of controlling a switch-mode power supply.

FIG. 5 illustrates exemplary switch control voltage and inductor current waveforms for a switch-mode power supply with enhanced current source capability.

FIG. 6 illustrates exemplary switch control voltage and inductor current waveforms for a switch-mode power supply with enhanced current source capability where the switch is turned back on at the beginning of a new switching cycle.

FIG. 7 illustrates exemplary switch control voltage and inductor current waveforms for a switch-mode power supply with enhanced current source capability where the switch is turned back on at the beginning of a new switching cycle with the inductor current above the measurement range.

FIG. 8 illustrates exemplary switch control voltage and inductor current waveforms for a switch-mode power supply with enhanced current source capability where the switch is turned back on at the beginning of a new switching cycle after the inductor current reaches zero.

FIG. 9 illustrates exemplary switch control voltage and inductor current waveforms for a switch-mode power supply with enhanced current source capability where the switch is turned back on when the inductor current reaches a threshold (e.g., hysteresis) below the new current limit threshold.

FIG. 10 illustrates exemplary switch control voltage and inductor current waveforms for a switch-mode power supply with enhanced current source capability where the switch turns off after the inductor current reaches the new current limit threshold regardless of the switching cycle.

### DETAILED DESCRIPTION

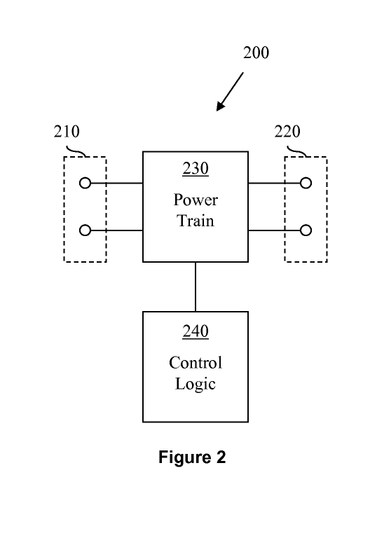

FIG. 2 illustrates a block diagram of an exemplary switch-mode power supply 200 with enhanced current source capability. The power supply 200 includes an input port 210 and an output port 220. In one embodiment (not shown), the input port 210 connects to a source, while the output port 220 connects to a load. The power supply 200 also includes a power train 230 operably connected to the input port 210 and the output port 220. The power supply 200 further includes a control logic 240 operably connected to the power train 230 and configured to control the power train 230.

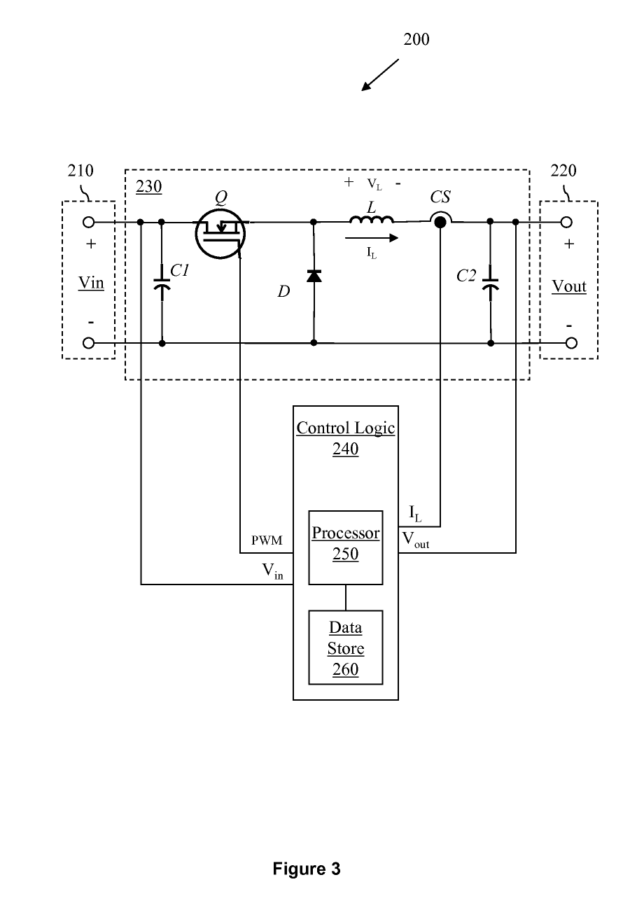

FIG. 3 illustrates a circuit diagram of the exemplary switch-mode power supply 200 with enhanced current source capability. For purposes of illustration, the power supply 200 is shown as a DC-DC converter including a power train 230 configured in a buck topology. However, the power supply 200 may be any type of switch-mode power supply or converter including, but not limited, to AC-DC converters, DC-AC converters, AC-AC converters, boost, forward, flyback, buck-boost, push-pull, half bridge, full bridge converters, uninterruptible power supplies (UPS), and so on.

The power supply 200 includes the input port 210 and the output port 220. The power supply 200 also includes the power train 230 operably connected to the input port 210 and the output port 220.

In the illustrated embodiment, the power train 230 includes an input capacitor C1, a switch Q, a diode D, an inductor L, a current sensor CS, and an output capacitor C2 configured in a buck topology. In one embodiment (not shown), the power train includes a different number of the illustrated components. For example, the power train may include more than one inductor, switch or diode, or the power train may include more or less than two capacitors. In another embodiment (not shown), one or more inductors may not be discrete components, but instead may be part of other components (e.g., flyback transformer, and so on).

In the illustrated embodiment, the current sensor CS is connected in series with the inductor L. In another embodiment (not shown), the current sensor is located elsewhere in the circuit where inductor current or equivalent may be measured. In one embodiment (not shown), the power train includes more than one current sensor, while in another embodiment (not shown), the power train does not include a current sensor.

The power supply 200 further includes the control logic 240 operably connected to the power train 230 and configured to control the power train 230. The control logic periodically calculates current through inductor L and controls operation of the power train 230 by switching the switch Q based at least in part on the calculated current.

The control logic 240 includes a processor 250 and a data store 260 in communication with the processor 250.

The data store 260 stores data representing circuit and component parameters.

Circuit parameters include, but are not limited to, prior or current operating conditions of the power supply 200 including prior or current on/off state of the switch Q, switching frequency, input voltage, output voltage, temperature (e.g., ambient, component, a temperature inside an enclosure of the switch-mode power supply, etc.), prior or current load current, maximum load, and so on.

Component parameters include, but are not limited to, parameters of the switch Q including on resistance, total energy capability, rise and fall times, safe operating area, thermal resistance, conduction losses, switching losses, maximum die temperature, and so on. Component parameters may further include known parameters of the printed circuit boards, circuit enclosures, and so on. Component parameters further include the inductance of the inductor L in and out of saturation.

The processor 250 calculates inductor current based at least in part on the data stored in the data store 260. Based on the calculated inductor current, the processor 250 issues signals that control the switching of the switch Q.

### Inductor Current Calculation

The change dI_{L} in the current I_{L} through the inductor L is a function of the voltage V_{L} across the inductor, the inductance of the inductor L, and the conduction time or pulse width dt of the PWM signal to switch Q.

$${dI}_{L} = \frac{{V}_{L}}{L} dt \qquad Eq . 1$$

In one embodiment, the voltage V_{L} across the inductor L is known. In another embodiment, the voltage V_{L} across the inductor L is measured. In yet another embodiment, the voltage V_{L} across the inductor L is calculated based on measured or known quantities. In the illustrated embodiment, the control logic 240 measures the source voltage Vin and the output voltage Vout. The measured values are stored in the data store 260. The processor 250 calculates the voltage across the inductor V_{L} from the measured values of the source voltage Vin and the output voltage Vout. The determination of the voltage V_{L} will vary depending on the circuit topology and specific circuit configuration.

The inductance of inductor L is determined based in part on the magnetization curve of the chosen inductor L. In one embodiment, the inductor L has a predictable inductance in and out of saturation. An example of an inductor having such predictable behavior includes, but is not limited to, the inductor disclosed in U.S. Pat. No. 7,205,875 to Oughton, Jr. et al. Such an inductor has stable and predicable inductance values in and out of saturation, which simplifies the inductance calculation. In another embodiment, the inductor L is any inductor for which the magnetization curve is known. From the known magnetization curve, the inductance is determined.

The pulse width dt or conduction time of the switch Q is known to the control logic 240 since the processor 250 provides the PWM signal that controls the pulse width dt or conduction time of the switch Q.

In one embodiment, the control logic 240 calculates inductor current I_{L} only when the inductor current as measured by current sensor CS exceeds the measurement range. In another embodiment, the control logic 240 calculates inductor current I_{L} periodically regardless of whether the inductor current as measured by current sensor CS exceeds the measurement range. In one embodiment (not shown), the power train 230 does not include the current sensor CS and the control logic 240 does not measure, but only calculates the inductor current I_{L}.

### Current Limit Threshold

The control logic 240 controls the operation of the power train 230 at least in part by switching the switch Q off based on the calculated current through the inductor L rising to reach or exceed a current limit threshold. The current limit threshold may be predetermined or calculated.

In one embodiment, the current limit threshold is a predetermined threshold within the current measurement range of the control logic 240. In another embodiment, the current limit threshold is a predetermined threshold outside the current measurement range of the control logic 240.

In one embodiment, the current limit threshold is calculated. In another embodiment, the current limit threshold is calculated periodically and so it varies dynamically based on circuit and component parameters.

In one embodiment, the current limit threshold is calculated based on an operating profile. For example, a user may indicate an operating profile based on a desired maximum output current. In another example, the operating profile is factory chosen based on circuit component parameters such as component parameters relating to the switch Q.

### Methodology

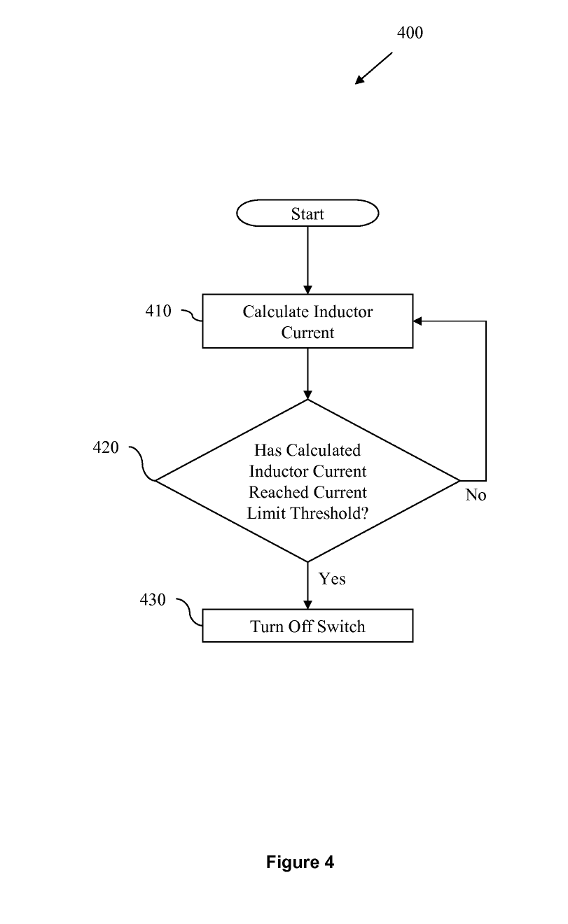

Example methods may be better appreciated with reference to the flow diagrams of FIG. 4. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown or described. Moreover, less than all the illustrated blocks may be required to implement an example methodology. Furthermore, additional or alternative methodologies can employ additional, not illustrated blocks.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various hardware approaches as well as various programming approaches like machine language, procedural, object oriented or artificial intelligence techniques.

In one example, methodologies are implemented as processor executable instructions or operations provided on a data store. Thus, in one example, a data store may store processor executable instructions operable to perform the method of FIG. 4.

While FIG. 4 illustrates various actions occurring in serial, it is to be appreciated that various actions illustrated in FIG. 4 could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 4 illustrates a method 400 for controlling a switch-mode power supply including at least one switch and one inductor. With the switch on, at 410, the method 400 periodically calculates inductor current. At 420, the method 400 determines whether the calculated inductor current has reached a current limit threshold. If the calculated inductor current has reached the current limit threshold, at 430, the method 400 turns off the switch.

In one embodiment, the switch is turned back on based on the calculated inductor current decreasing below a threshold. Example thresholds include a threshold corresponding to a hysteresis of the current limit threshold, the upper limit of the current measurement range, the inductor current reaching zero, and so on.

In one embodiment, the method determines the current limit threshold based on circuit and component parameters. In this embodiment, the method includes receiving data representing parameters of the switch-mode power supply and determining the current limit threshold based at least in part on the data representing the parameters of the circuit and components of the switch-mode power supply.

In another embodiment, the method determines the current limit threshold based on prior or current operating state of the switch-mode power supply. In this embodiment, the method includes receiving data representing at least one of prior and current operating state of the switch-mode power supply, and determining the current limit threshold based at least in part on the data representing the at least one of prior and current operating state of the switch-mode power supply. Prior and current operating state of the switch-mode power supply prior include, but are not limited to, current or previous on/off state of the at least one switching device, switching frequency of the switch-mode power supply, current or prior output voltage of the switch-mode power supply, current or prior output load of the switch-mode power supply, and so on.

In one embodiment, the method determines the current limit threshold based on a user selected profile. In this embodiment, the method includes receiving data representing a user-selected current profile, and determining the current limit threshold based at least in part on the data representing the user-selected current profile.

In another embodiment, the method determines the current limit threshold based on a factory selected profile. In this embodiment, the method includes receiving data representing a factory selected current profile, and determining the current limit threshold based at least in part on the data representing the factory selected current profile.

### Enhanced Current Source Capability

Calculating the inductor current allows the power supply to source higher output relative to the conventional measured inductor current set up where the inductor current must be within the current measurement range for the control logic to capture. In a power supply where the inductor current is calculated instead of measured, a higher, new current limit threshold may be set above the measurement range so that maximum output current may be sourced to the fault.

In one embodiment, the switch is turned off on a cycle by cycle basis or when the inductor current reaches the new current limit threshold. In another embodiment, the switch does not turn off on a cycle by cycle basis, but instead the switch turns off when the inductor current reaches the new current limit threshold.

The time at which the switch is turned back on may vary. For example, the switch may be turned back on when the inductor current reaches zero, when the inductor current is below the new current limit minus some hysteresis, when the inductor current is below the new current limit but still above the measurement range, when the inductor current is below the new current limit and in measurement range, at the beginning of a new switching cycle, at the beginning of a new switching cycle after the inductor current reaches zero, and so on.

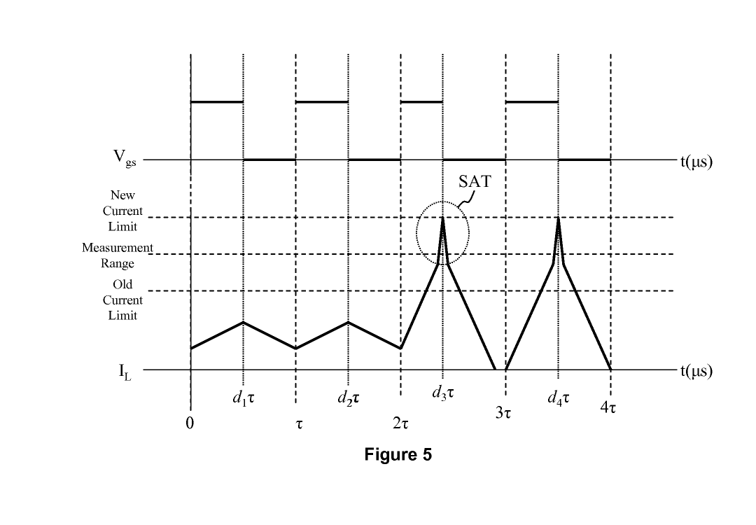

FIG. 5 illustrates exemplary switch control voltage V_{gs} (e.g., gate-source voltage, base-emitter voltage, and so on) and inductor current I_{L} waveforms for a switch-mode power supply with enhanced current source capability.

At time zero the switch turns on and the inductor current ramps up. The switch remains on for the duration of the duty cycle until at d₁τ when the switch turns off and the inductor current ramps down. The second cycle is similar to the first. At time τ the switch turns on and the inductor current ramps up. The switch remains on for the duration of the duty cycle until at d₂τ when the switch turns off and the inductor current ramps down.

On the third cycle, at time 2τ, the switch turns on and the inductor currents ramps up steeply. The steep rise in the inductor current may be due to a fault (e.g., short circuit, overload, and so on) connected to the output of the switch-mode power supply. The inductor current reaches and goes beyond the old current limit threshold. The inductor current also reaches and goes beyond saturation SAT of the inductor where the slope of the inductor current rises even faster. The inductor current also reaches and goes beyond the measurement range beyond which the control logic could not measure the inductor current. Eventually, at d₃τ the calculated inductor current reaches the new current limit threshold and the switch is turned off.

With the switch off, the inductor current ramps down all the way to zero. The switch does not turn back on until the beginning of the next cycle at time 3τ when once again the inductor current rises rapidly until it hits the new current limit threshold at d₄τ. At d₄τ the switch turns off and the inductor current ramps down.

The actual inductor current closely resembles the calculated inductor current. Thus, the actual current available has increased by the difference between the old current limit threshold and the new current limit threshold. The increased current is available to clear the fault.

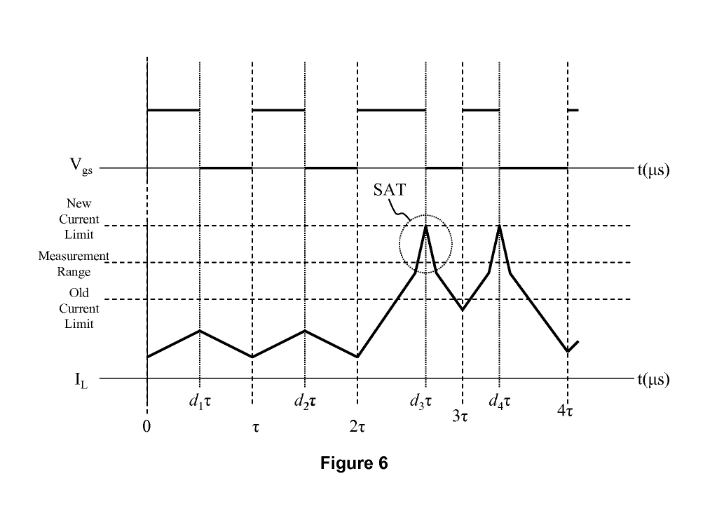

FIG. 6 illustrates exemplary switch control voltage V_{gs} (e.g., gate-source voltage, base-emitter voltage, and so on) and inductor current I_{L} waveforms for a switch-mode power supply with enhanced current source capability where the switch is turned back on at the beginning of a new switching cycle once the inductor current is back within the measurement range.

At time zero the switch turns on and the inductor current ramps up. The switch remains on for the duration of the duty cycle until at d₁τ when the switch turns off and the inductor current ramps down. The second cycle is similar to the first. At time τ the switch turns on and the inductor current ramps up. The switch remains on for the duration of the duty cycle until at d₂τ when the switch turns off and the inductor current ramps down.

On the third cycle, at time 2τ, the switch turns on and the inductor currents ramps up steeply. The steep rise in the inductor current may be due to a fault (e.g., short circuit, overload, and so on) connected to the output of the switch-mode power supply. The inductor current reaches and goes beyond the old current limit threshold. The inductor current also reaches and goes beyond saturation SAT of the inductor where the slope of the inductor current rises even faster. The inductor current also reaches and goes beyond the measurement range beyond which the control logic could not measure the inductor current. Eventually, at d₃τ the calculated inductor current reaches the new current limit threshold and the switch is turned off.

With the switch off, the inductor current ramps down. The switch turns back on at the beginning of the new cycle at time 3τ where the inductor current is not yet zero, but the inductor current is back within the measurement range. Once again the inductor current rises rapidly until it hits the new current limit threshold at d₄τ. At d₄τ the switch turns off and the inductor current ramps down. The switch turns back on at time 4τ even though the inductor current is not yet zero.

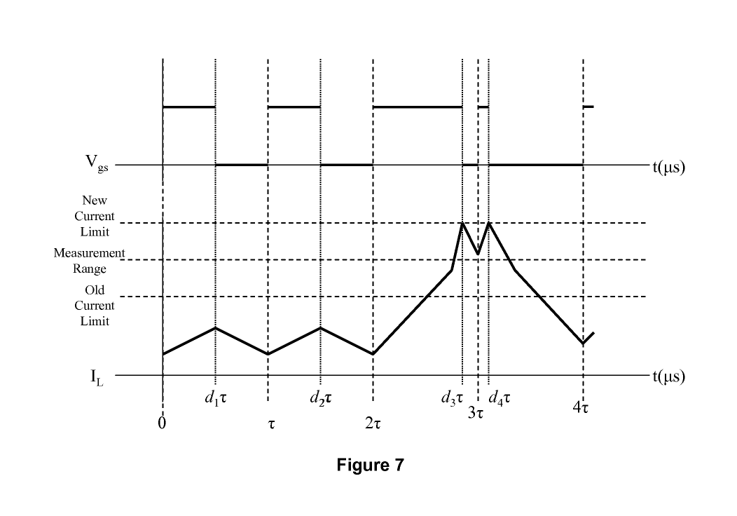

FIG. 7 illustrates exemplary switch control voltage V_{gs} (e.g., gate-source voltage, base-emitter voltage, and so on) and inductor current I_{L} waveforms for a switch-mode power supply with enhanced current source capability where the switch is turned back on at the beginning of a new switching cycle even though the inductor current remains above the measurement range and the old current limit.

At time zero the switch turns on and the inductor current ramps up. The switch remains on for the duration of the duty cycle until at d₁τ when the switch turns off and the inductor current ramps down. The second cycle is similar to the first. At time τ the switch turns on and the inductor current ramps up. The switch remains on for the duration of the duty cycle until at d₂τ when the switch turns off and the inductor current ramps down.

On the third cycle, at time 2τ, the switch turns on and the inductor currents ramps up steeply. The steep rise in the inductor current may be due to a fault (e.g., short circuit, overload, and so on) connected to the output of the switch-mode power supply. The inductor current reaches and goes beyond the old current limit threshold. The inductor current also reaches and goes beyond saturation of the inductor where the slope of the inductor current rises even faster. The inductor current also reaches and goes above the measurement range outside of which the control logic could not measure the inductor current. Eventually, at d₃τ the calculated inductor current reaches the new current limit threshold and the switch is turned off.

With the switch off, the inductor current ramps down. The switch turns back on at time 3τ at the beginning of the new cycle even though the inductor current is not yet zero and even though the inductor current is still outside of the measurement range. Once again the inductor current rises rapidly until it hits the new current limit threshold at d₄τ. At d₄τ the switch turns off and the inductor current ramps down. The switch turns back on at time 4τ at the beginning of the new cycle even though the inductor current is not yet zero, although this time the inductor current is inside measurement range.

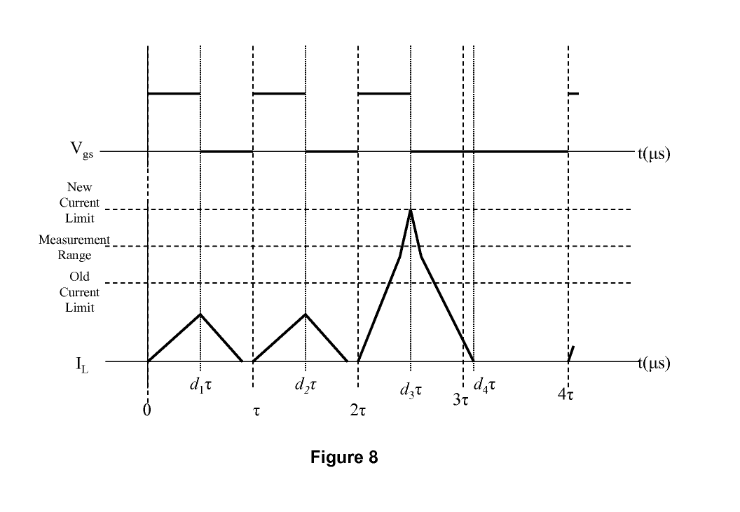

FIG. 8 illustrates exemplary switch control voltage V_{gs} (e.g., gate-source voltage, base-emitter voltage, and so on) and inductor current I_{L} waveforms for a switch-mode power supply with enhanced current source capability where the switch is turned back on at the beginning of a new switching cycle after the inductor current reaches zero.

At time zero the switch turns on and the inductor current ramps up. The switch remains on for the duration of the duty cycle until at d₁τ when the switch turns off and the inductor current ramps down. The second cycle is similar to the first. At time τ the switch turns on and the inductor current ramps up. The switch remains on for the duration of the duty cycle until at d₂τ when the switch turns off and the inductor current ramps down.

On the third cycle, at time 2τ, the switch turns on and the inductor currents ramps up steeply. The steep rise in the inductor current may be due to a fault (e.g., short circuit, overload, and so on) connected to the output of the switch-mode power supply. The inductor current reaches and goes beyond the old current limit threshold. The inductor current also reaches and goes beyond saturation of the inductor where the slope of the inductor current rises even faster. The inductor current also reaches and goes above the measurement range outside of which the control logic could not measure the inductor current. Eventually, at d₃τ the calculated inductor current reaches the new current limit threshold and the switch is turned off.

With the switch off, the inductor current ramps down. The switch does not turn back on at time 3τ at the beginning of the new cycle because inductor current has not yet reached zero. At d₄τ inductor current reaches zero. The switch turns back on at time 4τ at the beginning of the new cycle after the inductor current reaches zero. In one embodiment (now shown), the switch turns back on after the inductor current reaches zero before the beginning of what would have been a new cycle.

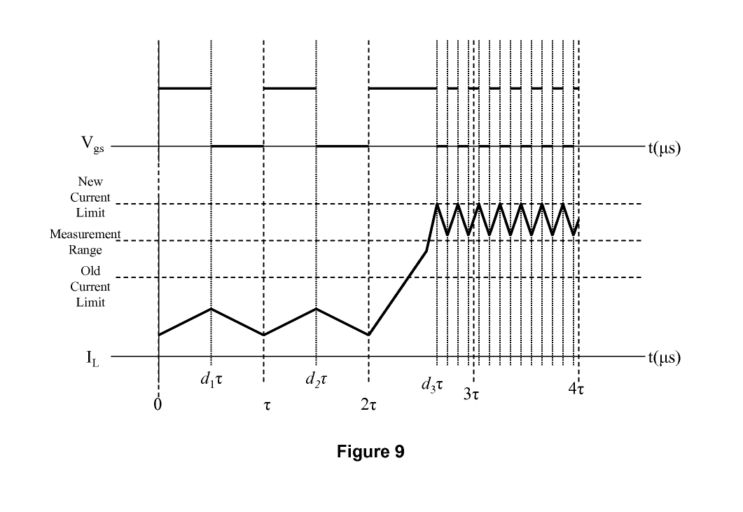

FIG. 9 illustrates exemplary switch control voltage V_{gs} (e.g., gate-source voltage, base-emitter voltage, and so on) and inductor current I_{L} waveforms for a switch-mode power supply with enhanced current source capability where the switch is turned back on when the inductor current reaches some threshold (e.g., hysteresis) below the new current limit threshold even though the inductor current remains above the measurement range and the old current limit.

At time zero the switch turns on and the inductor current ramps up. The switch remains on for the duration of the duty cycle until at d₁τ when the switch turns off and the inductor current ramps down. The second cycle is similar to the first. At time τ the switch turns on and the inductor current ramps up. The switch remains on for the duration of the duty cycle until at d₂τ when the switch turns off and the inductor current ramps down.

On the third cycle, at time 2τ, the switch turns on and the inductor currents ramps up steeply. The steep rise in the inductor current may be due to a fault (e.g., short circuit, overload, and so on) connected to the output of the switch-mode power supply. The inductor current reaches and goes beyond the old current limit threshold. The inductor current also reaches and goes beyond saturation of the inductor where the slope of the inductor current rises even faster. The inductor current also reaches and goes above the measurement range outside of which the control logic could not measure the inductor current. Eventually, at d₃τ the calculated inductor current reaches the new current limit threshold and the switch is turned off.

With the switch off, the inductor current ramps down until the inductor current reaches a level that is deemed safe for operation (e.g., current limit hysteresis). At that point, the switch turns back on even though the inductor current is not yet zero and even though the inductor current is still above the measurement range. Once again the inductor current rises rapidly until it hits the new current limit threshold. The cycle continues until the fault clears or until the control logic determines based on circuit parameters that the new current limit threshold should be lowered to protect the circuit from damage (e.g., overcurrent, overheating, and so on) or that the switch should otherwise be turned off. In this example, the switching frequency may vary depending on the new current limit threshold, the hysteresis, the fault current, and so on.

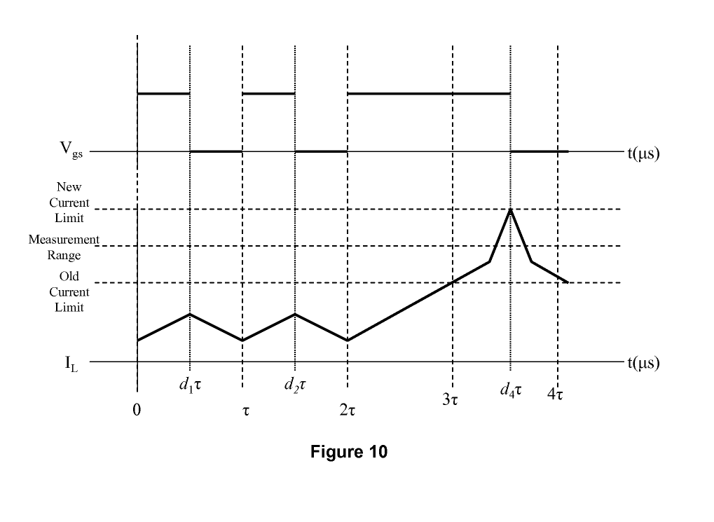

FIG. 10 illustrates exemplary switch control voltage V_{gs} (e.g., gate-source voltage, base-emitter voltage, and so on) and inductor current I_{L} waveforms for a switch-mode power supply with enhanced current source capability where the switch does not turn off until the inductor current reaches the new current limit threshold.

At time zero the switch turns on and the inductor current ramps up. The switch remains on for the duration of the duty cycle until at d₁τ when the switch turns off and the inductor current ramps down. The second cycle is similar to the first. At time τ the switch turns on and the inductor current ramps up. The switch remains on for the duration of the duty cycle until at d₂τ when the switch turns off and the inductor current ramps down.

On the third cycle, at time 2τ, the switch turns on and the inductor currents ramps up steeply. The steep rise in the inductor current may be due to a fault (e.g., short circuit, overload, and so on) connected to the output of the switch-mode power supply. The inductor current reaches and goes beyond the old current limit threshold. The inductor current is allowed to keep rising past time 3τ where a new cycle would have otherwise started. The inductor current also reaches and goes beyond saturation of the inductor where the slope of the inductor current rises even faster. The inductor current also reaches and goes above the measurement range outside of which the control logic could not measure the inductor current. Eventually, at d₄τ the calculated inductor current reaches the new current limit threshold and the switch is turned off.

With the switch off, the inductor current ramps down. The switch maybe turned back on when the inductor current reaches some safe threshold outside or within the measurement range, when the inductor current reaches zero, or at the beginning of a new cycle. In this example, the switching frequency may vary depending on the new current limit threshold, the fault current, and so on.

In the above examples, since the actual inductor current closely resembles the calculated inductor current, significant additional actual current, the difference between the old current limit threshold and the new current limit threshold, is available to clear the fault.

### DEFINITIONS

“Data store,” as used herein, refers to a physical or logical entity that can store data. A data store may be, for example, a database, a table, a file, a list, a queue, a heap, a memory (RAM., ROM, flash, and so on), a hard drive, a register, and so on. A data store may reside in one logical or physical entity or may be distributed between two or more logical or physical entities.

“Logic,” as used herein, includes but is not limited to hardware, firmware, software or combinations of each to perform function or action, or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which components are “operably connected,” is one by which the operably connected components or the operable connection perform its intended purpose. For example, two components may be operably connected to each other directly or through one or more intermediate components. An “operable connection,” or a connection by which components are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. In another example, two components can be operably connected by being able to communicate signals to each other directly or through one or more intermediate components such as a conductor, a wire, a processor, a logic, an operating system, or other component.

A “processor,” as used herein, includes, but is not limited to, microprocessors, microcontrollers, digital signal processors (DSP), dual microprocessors, and other multi-processor architectures.

“Signal,” as used herein, includes but is not limited to one or more electrical or optical signals, analog or digital signals, data, one or more computer or processor instructions, messages, a bit or bit stream, or other means that can be received, transmitted or detected.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present disclosure illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details and illustrative examples shown or described. Accordingly, departures may be made from such details without departing from the spirit or scope of the claimed invention. Moreover, the foregoing embodiments are illustrative, and no single feature or element is essential to all possible combinations that may be claimed in this or a later application.

What is claimed is:

1. A switch-mode power supply comprising:
an input port;
an output port;
a power train operably connected to the input port and the output port, where the power train includes at least one inductor and at least one switching device; and
a control logic configured to periodically calculate an equivalent current to current through the at least one inductor and further configured to control operation of the power train at least in part by switching the at least one switching device based at least in part on the calculated equivalent current.

2. The switch-mode power supply of claim 1, where the control logic calculates the equivalent current based in part on a magnetizing curve corresponding to the at least one inductor.

3. The switch-mode power supply of claim 1, where the control logic calculates the equivalent current based in part on at least one of:
inductance of the at least one inductor; and
inductance in saturation of the at least one inductor.

4. The switch-mode power supply of claim 1, where the control logic is configured to control operation of the power train at least in part by switching the at least one switching device off based on the calculated equivalent current rising to reach or exceed a current limit threshold.

5. The switch-mode power supply of claim 4, where the control logic is configured to calculate the current limit threshold based on at least one of:
component parameters of components of the power train,
at least one of prior and current operating conditions of the power train, and
a current profile.

6. The switch-mode power supply of claim 5, where the component parameters include at least one of:
on resistance of the at least one switching device;
total energy capability of the at least one switching device;
rise time of the at least one switching device;
fall time of the at least one switching device;
safe operating area of the at least one switching device;
thermal resistance of the at least one switching device;
conduction losses of the at least one switching device; and
switching losses of the at least one switching device.

7. The switch-mode power supply of claim 5, where the at least one of prior and current operating conditions includes at least one of:
prior on/off state of the at least one switching device,
current on/off state of the at least one switching device,
switching frequency of the at least one switching device,
output voltage of the power train,
ambient temperature,
temperature of the at least one switching device,
a temperature inside an enclosure of the switch-mode power supply,
prior output load of the power train, and
current output load of the power train.

8. The switch-mode power supply of claim 5, where the current profile includes at least one of:
a user selected current profile, and
a factory selected current profile.

9. A method of controlling a switch-mode power supply, the method comprising:
calculating inductor current through at least one inductor in the switch-mode power supply; and
switching at least one switching device off based on the calculated inductor current reaching a current limit threshold.

10. The method of claim 9, further comprising:
switching the at least one switching device on based on the calculated inductor current being at least one of:
below the current limit threshold,
below a second threshold corresponding to a hysteresis of the current limit threshold,
below a third threshold corresponding to an upper limit of a current measurement range, and
substantially zero.

11. The method of claim 9, further comprising:
receiving data representing at least one of:
(a) parameters of components of the switch-mode power supply, and
(b) one or more of prior and current operating state of the switch-mode power supply; and
determining the current limit threshold based on the received data.

12. The method of claim 11, where the one or more of at least one of the prior and current operating conditions of the switch-mode power supply includes at least one of:
prior on/off state of the at least one switching device,
current on/off state of the at least one switching device,
switching frequency of the switch-mode power supply,
output voltage of the switch-mode power supply,
temperature of the at least one switching device,
ambient temperature,
a temperature inside an enclosure of the switch-mode power supply,
prior output load of the switch-mode power supply, and
current output load of the switch-mode power supply.

13. The method of claim 11,
where the parameters of the components include at least one of on resistance of the at least one switching device, total energy capability of the at least one switching device, rise time of the at least one switching device, fall time of the at least one switching device, safe operating area of the at least one switching device, thermal resistance of the at least one switching device, conduction losses of the at least one switching device, and switching losses of the at least one switching device, inductance of the at least one inductor.

14. The method of claim 9, further comprising:
receiving data representing a user-selected current profile; and
determining the current limit threshold based at least in part on the data representing the user-selected current profile.

15. The method of claim 9, further comprising:
receiving data representing a factory selected current profile; and
determining the current limit threshold based at least in part on the data representing the factory selected current profile.

16. A switch-mode power supply comprising:
an input port;
an output port;
a power circuit operably connected to the input port and the output port, where the power circuit includes at least one inductor and at least one switching device;
a data store configured to store data; and
a processor configured to calculate a current corresponding to current through the at least one inductor based at least in part on the stored data, where the processor is further configured to generate a signal that causes switching of the at least one switching device based at least in part on the calculated current.

17. The switch-mode power supply of claim 16,
where the stored data includes:
voltage across the at least one inductor,
a parameterized magnetizing curve corresponding to the at least one inductor, and
on time of the at least one switching device, and
where the processor is configured to calculate the current corresponding to current through the at least one inductor based at least in part on the voltage across the at least one inductor, the parameterized magnetizing curve corresponding to the at least one inductor, and the on time of the at least one switching device.

18. The switch-mode power supply of claim 16, where the processor is configured to cause the switching of the at least one switching device at a frequency based at least in part on the calculated current.

19. The switch-mode power supply of claim 16, where the processor is configured to cause the at least one switching device to switch off based on the calculated current reaching or exceeding a current limit threshold above the processor's current measurement range and to cause the at least one switching device to switch on based at least in part on the calculated current decreasing below a second threshold above the processor's current measurement range.

20. The switch-mode power supply of claim 16, where the processor is configured to cause the at least one switching device to switch off based on the calculated current reaching or exceeding a current limit threshold above the processor's current measurement range and to cause the at least one switching device to switch on based at least in part on the calculated current decreasing below a second threshold below the processor's current measurement range.
